(19) United States
(12) Patent Application Publication
(10) Pub. No.: US 2026/0135905 A1
(43) Pub. Date: May 14, 2026

(54) MANAGING UNIDIRECTIONAL DATA CHANNEL ASSIGNMENT

(71) Applicant: Connectify, Inc., Philadelphia, PA (US)

(72) Inventors: Alexander Gizis, Philadelphia, PA (US); Brian Prodoehl, Plymouth Meeting, PA (US); Kevin Cunningham, Swarthmore, PA (US)

(21) Appl. No.: 19/385,212

(22) Filed: Nov. 11, 2025

Related U.S. Application Data
(60) Provisional application No. 63/719,645, filed on Nov. 12, 2024.

(51) Int. Cl. H04L 67/06

(52) U.S. Cl. CPC H04L 67/06

(57) ABSTRACT

One example may include transmitting and receiving data by a device over one or more data channels, determining one or more of an upload data rate and a download data rate of the one or more data channels are below a data rate threshold, and bonding two or more of the data channels to create one or more of an aggregated upload data rate and an aggregated download data rate, wherein at least one of the two or more data channels is only used to transmit or receive data.

### TECHNICAL FIELD

This application relates to data management and more particularly to managing data channel assignment for data flow in a single direction.

### BACKGROUND

Client devices may be identified as being at a particular source and location and having specific attributes, such as a hardware device profile, an assigned IP address, an assigned network, etc. The use of client devices to perform various data access operations can be prohibited or at least limited by the settings and restrictions of the remote data sources that are being accessed by the client devices. For example, a client device may be attempting to access a secure and popular server for secure information, such as streaming content, secure order information, access to a protected account, etc.

A virtual private network (VPN) server is a tool that can offer an alternative to a client device’s normal network data traffic. Generally, a VPN server may use different network routes and perform encryption among other data management operations. When client devices desire to share data and related services with other client devices, the VPN server may provide a way to connect to the Internet and remote servers to download data and forward the data to one or more requesting client devices. One or more client devices may provide data sharing with one or more other client devices by receiving the shared data through the VPN server.

Aside from the VPN server, a number of channels used by a client device at any given time may vary depending on what channels are available and the identified needs of the client device. In some cases a client device may be simultaneously using a multitude of channels including but not limited to a Wi-Fi data channel, a cellular data channel, and a satellite data channel. The recent deployment of the STARLINK satellite network has made satellite data services more common and easier to achieve to users across the U.S. Bonding channels for optimal usage may not be limited to one data service but instead may include various different mediums and carriers being used in unison. Some of the available providers may offer more optimal download and/or upload speeds than other providers. Taking this into consideration, the strategies used to provide optimal data services may vary depending on the available resources at any given time.

### SUMMARY

One example embodiment may include a network configuration where available data services are selected and/or combined to provide optimal data services to a client device.

One example method may include transmitting and receiving data by a device over a number of bonded channels, determining an aggregated data rate in one or more data flow directions for the number of bonded channels, allocating at least one additional channel to the bonded channels in the one or more data flow directions, and determining whether the aggregated data rate in the one or more data flow directions has increased.

Another example method may include transmitting and receiving data by a device over one or more data channels, determining one or more of an upload data rate and a download data rate of the one or more data channels are below a data rate threshold, and bonding two or more of the data channels to create one or more of an aggregated upload data rate and an aggregated download data rate, wherein at least one of the two or more data channels is only used to transmit or receive data.

### BRIEF DESCRIPTION OF THE DRAWINGS

FIG. 1A illustrates a communication network used to support data management of client devices according to example embodiments.

FIG. 1B illustrates a communication network utilizing artificial intelligence to support data management of a client device according to example embodiments.

FIG. 2A illustrates a client device managing data services from two networks according to example embodiments.

FIG. 2B illustrates a client device managing data services from three networks where one network is used primarily for unidirectional data services according to example embodiments.

FIG. 2C illustrates a client device managing data services from three networks where two networks are used primarily for unidirectional data services according to example embodiments.

FIG. 2D illustrates a client device managing data services from four networks where three networks are used primarily for unidirectional data services according to example embodiments.

FIG. 3A illustrates an example flow diagram of an example data management process according to example embodiments.

FIG. 3B illustrates an example flow diagram of another example data management process according to example embodiments.

FIG. 4 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/ Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another.

It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

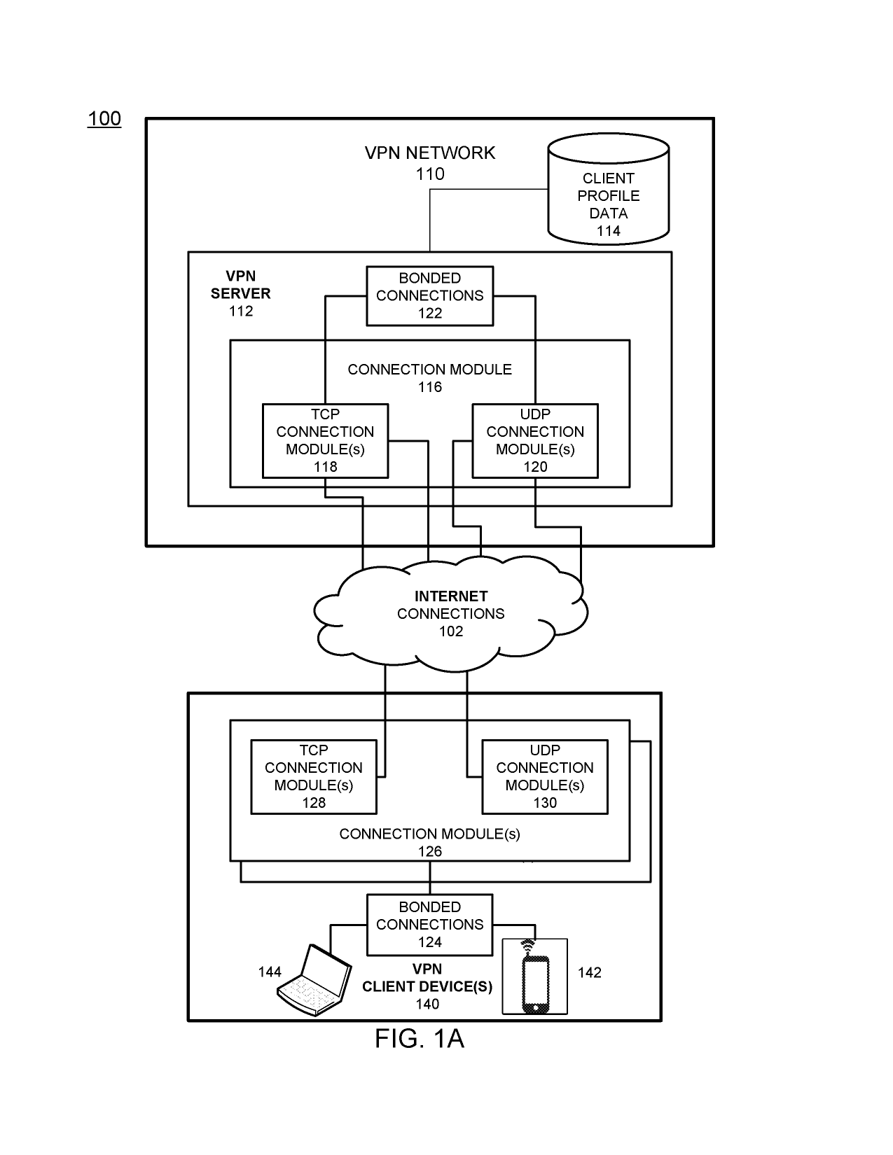

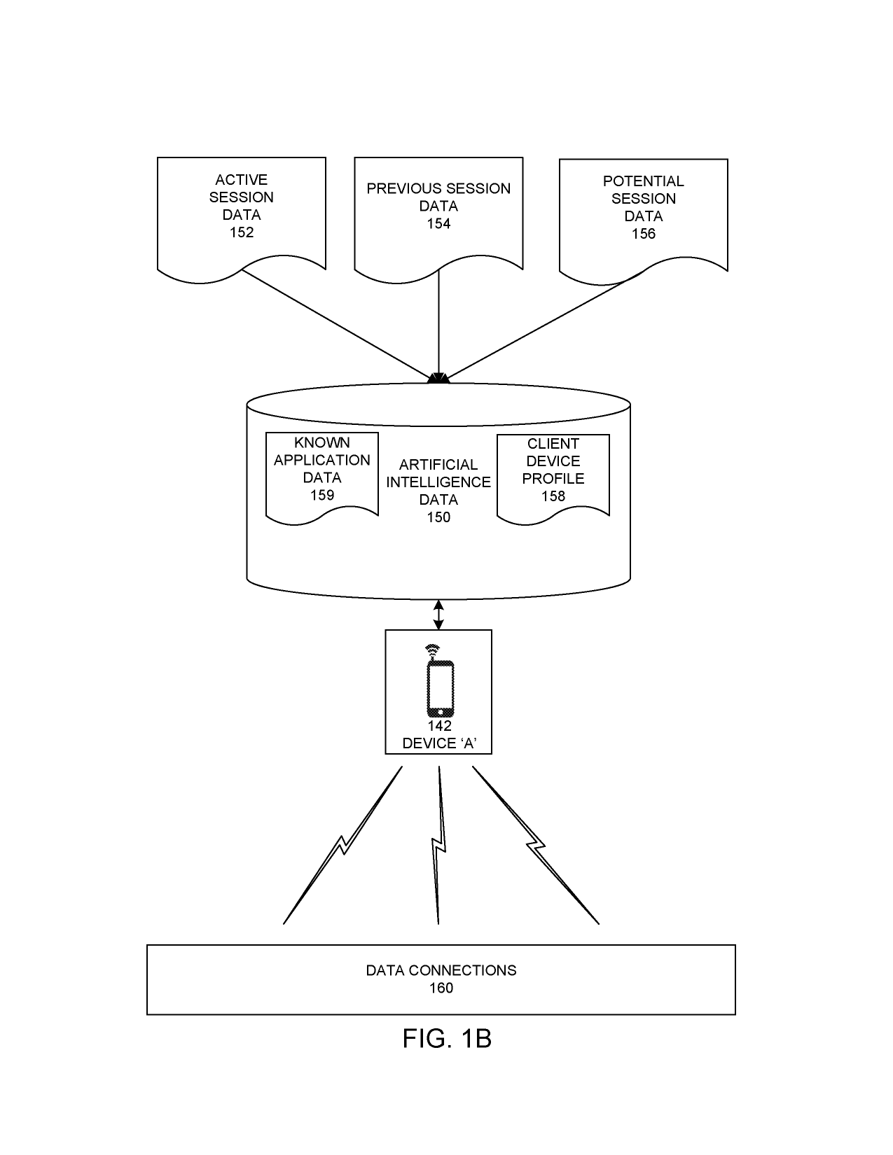

FIG. 1A illustrates an example data session network configuration according to example embodiments. Referring to FIG. 1A, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transports connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

Example embodiments may include a system, a method, a device, a non-transitory computer readable medium or any combination of such configurations which provide data services to a client device, such as a mobile device, smartphone, tablet, watch, eyewear, laptop, personal computer (PC) or similar device. When a device is attempting to connect to a network for access to a network of devices, such as a local or remote network (e.g., Internet), the client device 142 may be configured to identify and connect to a number of different networks.

FIG. 1B illustrates a communication network utilizing artificial intelligence to support data management of a client device according to example embodiments. Referring to FIG. 1B, the artificial intelligence databank 150 may store data collected from a particular client’s data sessions over time. In one example, a client device 142 may be utilizing one or more data connections which are managed by the VPN server 112. Each time a data connection 160 is made to establish a particular channel over an ISP, a cellular communication network, a Wi-Fi network, etc., the session data may be logged to include any one or more data performance metrics, such as data rates, delay, latency, jitter, packet loss, applications used, etc. Certain application data 159 may be stored, such as which applications were used and their specific data performance metrics while being used.

Each client device may have its own profile 158 identifying connections used, applications used, performance metric, etc. The AI databank 150 may be used by the VPN server 112 or the VPN client application installed on the device 142 to determine which data connections 160 should be used at any particular time. Over a period of time, the active session data of current data sessions 152, previous session data of past data sessions 154 and available data sources representing potential session data 156 may be weighed to determine which of the available connections 160 should be continued, restored, activated, etc.

In one example, a current session may include a cellular data channel that is being used to provide streaming data to the client device 142. The cellular data channel may be identified as having a limited download data rate that may not be ideal for the streaming application use and/or a connection that is considered a higher cost connection with limited data over time. Another available channel, such as a Wi-Fi channel may be activated as an additional channel to be bonded with the cellular channel in order to satisfy the download data rates of the streaming data for a period of time. The client device may then receive data from both connections intermittently and/or simultaneously. The AI data may be used by the VPN server to automatically initiate the Wi-Fi data connection to establish a second channel for immediate channel bonding with the existing data channel (i.e., cellular) to provide a larger overall data throughput (bits per second (bps)) to the client device 142.

Depending on the data channel(s) available, certain data channels may be half duplex or full duplex. The half duplex data channels may only provide data transmitting and receiving in one direction at a time, meaning data cannot be sent and received simultaneously. Half duplex channels may be limiting with real time applications since data may be sent and received in real time causing delays in conferences and other real time applications. Full duplex data channels may provide simultaneous data flow in both directions, however, may have slower data rates at any given time. In some cases, half duplex may be ideal especially if data is needed in one direction for a particular application, such as data streaming which downloads data regularly and uploads data less frequently.

In one example, the AI data available to the VPN server may designate a certain type of connection as an application specific connection. For example, a streaming application may be identified as compatible with a satellite data connection as a way to establish a connection and receive a download only channel due to the satellite offering larger download speeds than upload speeds. The AI function may identify a streaming application being used by the client device, and determine that an available satellite connection may be most appropriate for a certain period of time for such an application use in the download direction. The client device 142 may automatically establish the satellite connection while the streaming application is being used. Once the streaming has ended the satellite connection may be dropped and other channels may be used depending on the current application use of the client device 142. While the downloading is occurring, the other channels may be maintained but used less than usual and may be made available for other applications or data usage purposes. For example, the cellular and/or Wi-Fi channel that is available may be used for e-mail, messaging applications, etc., while the satellite is being used for the streaming application. The amount of data use of the satellite channel may be significantly larger than the amount of cellular or Wi-Fi data use during the streaming session. After the session and the application is no longer being used, the satellite channel may be dismissed or continued to be used but in a smaller capacity when compared with the data use of the cellular and/or Wi-Fi channel.

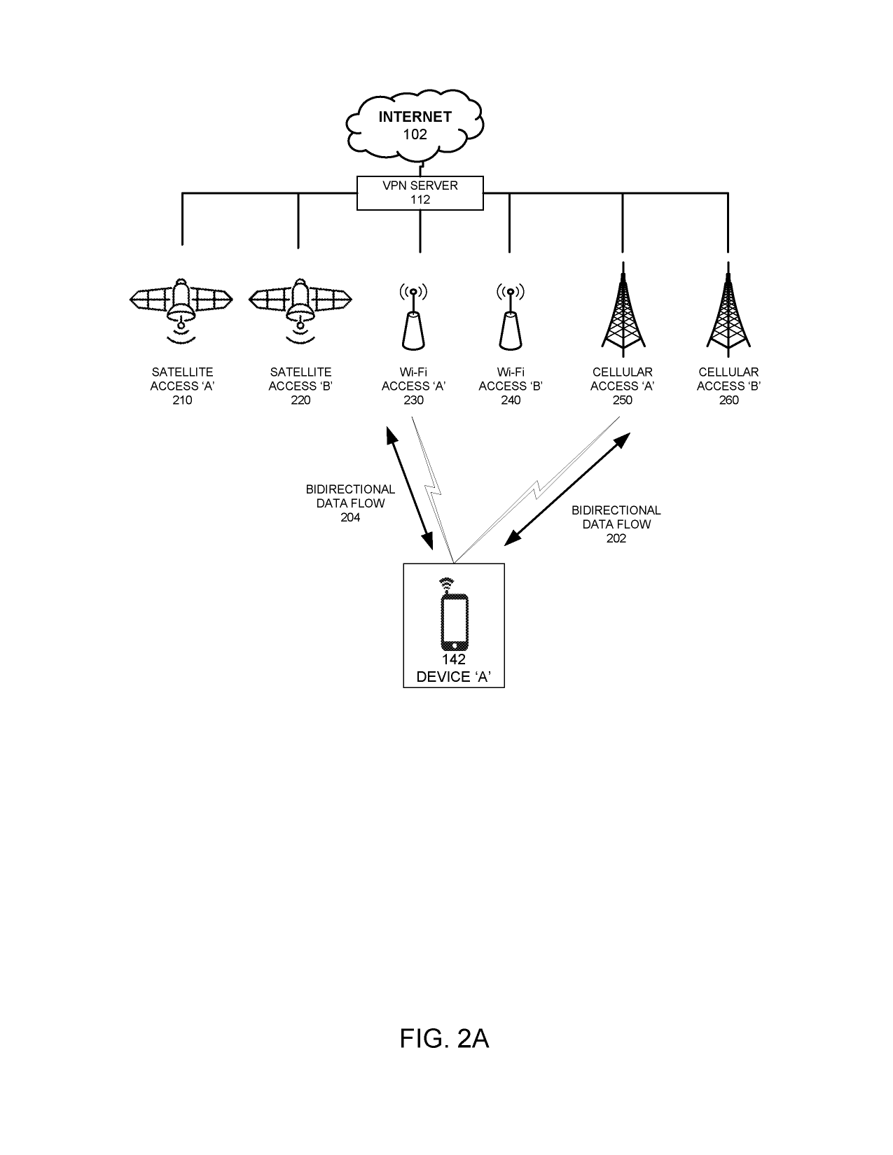

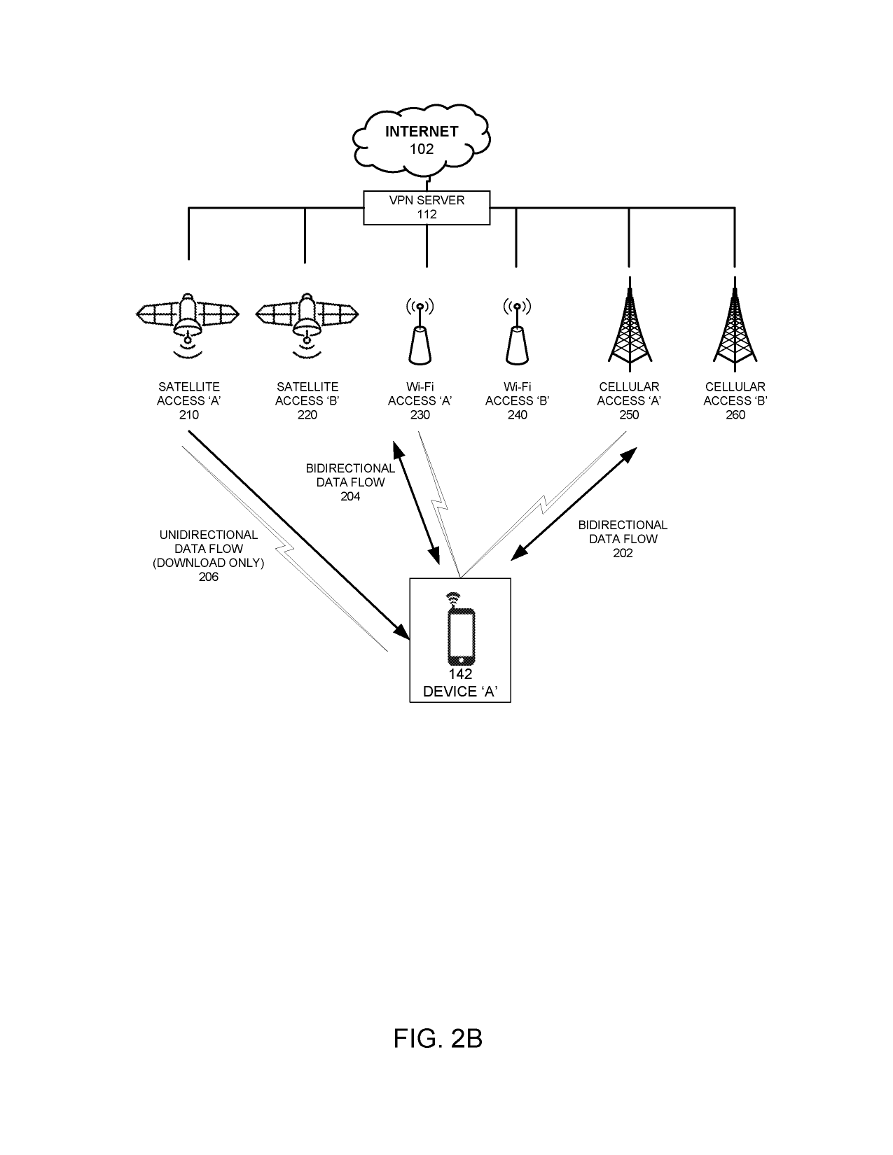

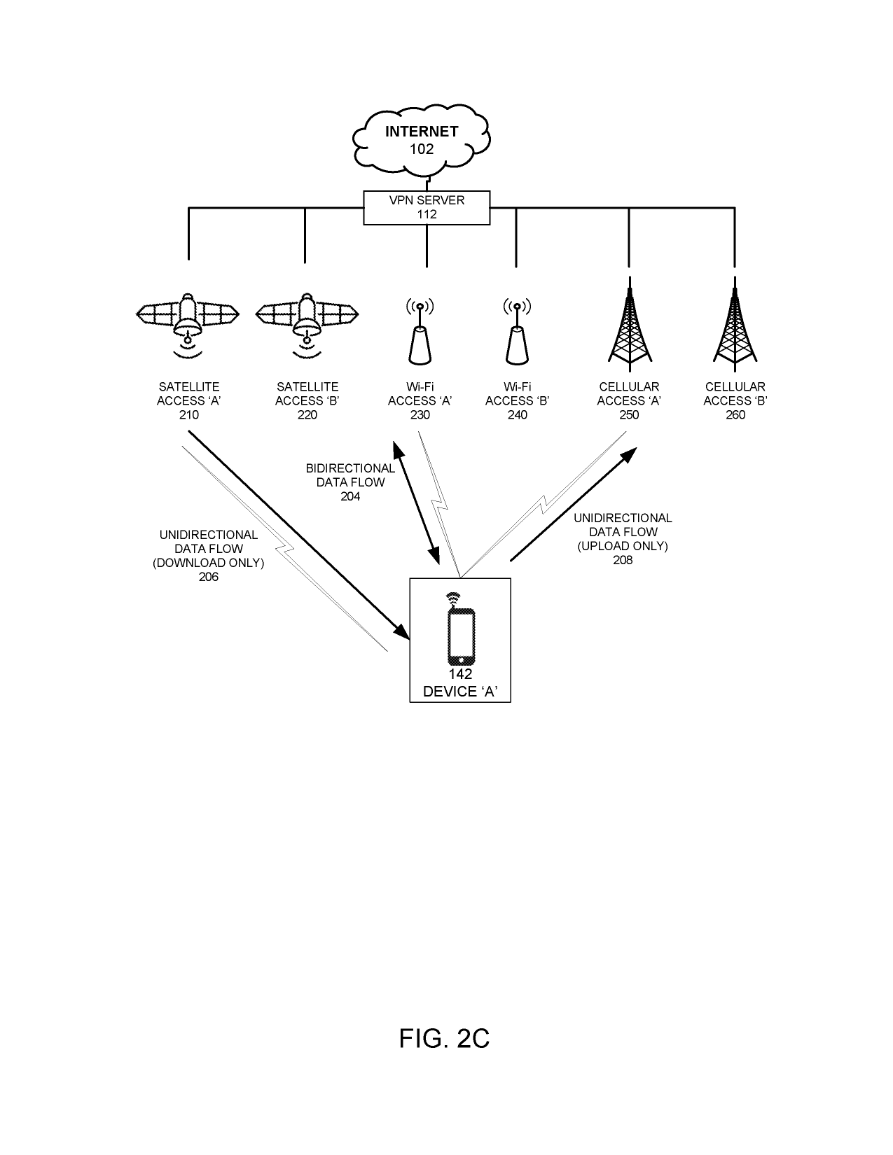

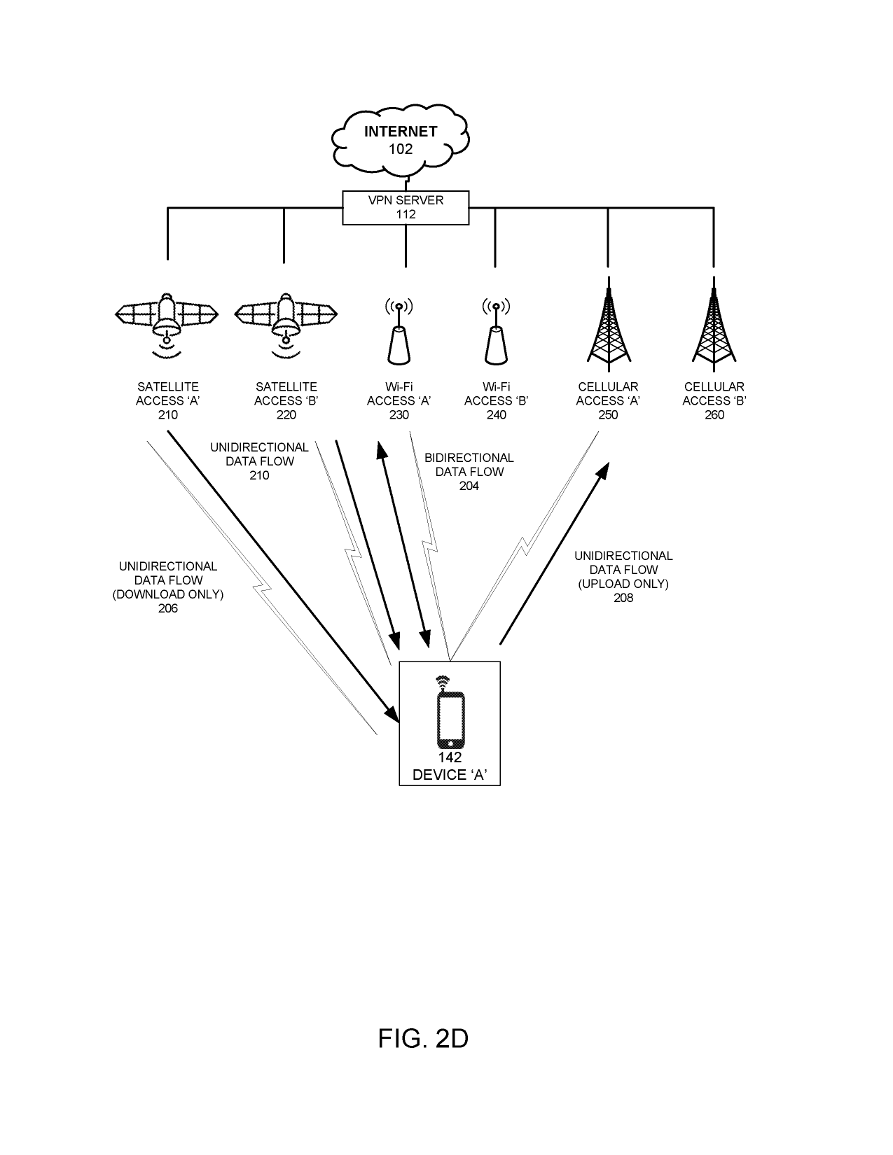

FIG. 2A illustrates a client device managing data services from two networks according to example embodiments. Referring to FIG. 2A, example networks may include a satellite data service provider 210/220 which may include additional data services options, such as a first 210 and second network 220. The satellite data service options may offer subscription data services, such as STARLINK or another consumer data service provider accessible by a client device 142. Other options may include Wi-Fi data access 230/240 offered by a local municipal service, a private data service or other data service. Lastly, a cellular data service 250/260 may be available based on a subscription service. Although two different networks are illustrated for each type of data service provider, one skilled in the art will appreciate that one, two, or more, or none, of any of the data service providers may be available at any given time to provide unidirectional, bidirectional, uninterrupted and/or intermittent data service to a particular client device 142.

In the example of FIG. 2A, the device 142 has initiated data communication services with two networks including one of the Wi-Fi access networks 230 and one of the cellular networks 250. The data flow may be bidirectional including the uploading and the downloading of data for both communication networks to establish bidirectional data flows 202 and 204. When two data channels are available, the connections may be bonded so that unique data packets are sent and received on each channel. The data may be for a common application or service but sent and received over multiple channels. The VPN server 112 may provide the bonding data service for a single client device 142. Also, other types of channel combining may be used, such as channel mirroring which provides duplicated data services where the same data packets are sent on both channels to increase redundancy in the event of data loss due to network degradation.

An aggregated data rate may be measured over time for each channel, such as upload data aggregation and download data aggregation. The aggregated data rate may be the aggregation of one or more channels which are available at a particular time. When one direction of data (e.g., upload or download) is not matching a data rate threshold requirement, additional data channels may be sought by the client device to increase the aggregated data rate in a single direction. The aggregated data rate in the upload direction may be denoted Ag(u) and the aggregated data rate in the download direction may be denoted Ag(d). A minimum threshold value may be used to identify a target upload data rate, which is denoted Th(u), and a minimum threshold value may be used to identify a target download rate, which is denoted Th(d). When either threshold is not achieved by a client device over a period of time, additional channels may be sought by the client device for other available networks to increase the data rates in one or more data flow directions until the thresholds are achieved.

FIG. 2B illustrates a client device managing data services from three networks where one network is used primarily for unidirectional data services according to example embodiments. Referring to FIG. 2B, in this example, the client device has identified another data service provider as a source of data. The two previous networks 230 and 250 were providing bidirectional data services to the client device. An additional data network was identified, such as the satellite network 210 which may provide a data service in both directions, however, an initial test may be performed by the client device to measure upload and download data services for a period of time (e.g., 10, 20, ‘N’ seconds). In this example, the satellite network 210 may offer a significantly larger download data rate (e.g., 25, 50, 100 Mbps) than a slower upload data rate (1, 5, 10, Mbps). The device may determine the upload data rate on the newest channel for the satellite network 210 is insufficient to aggregate with the other upload data rates of the other two channels for networks 230 and 250. In this case, the data rate evaluation process may determine to use the satellite network 210 for download only. The device 142 may then perform bonding or mirroring on all three channels 202, 204 and 206, however, channel 206 will be used for unidirectional data in the download direction only and any uploading required may be performed over channels 202 and 204. This approach optimizes the download speeds while not using network 210 for uploading data. Data uploading and downloading over one particular channel may interfere with one another. In other words, continuing to try to upload data on a data channel where the download data rate is optimal and the upload data rate is not optimal may interfere with the ability to receive an optimal download data rate. Therefore, such a channel may be designated as a biased channel used to only perform data services in a unidirectional manner, in this case, download only. The management of each channel’s use may be performed by a client application on the client device 142 and/or via the VPN server 112.

FIG. 2C illustrates a client device managing data services from three networks where two networks are used primarily for unidirectional data services according to example embodiments. Referring to FIG. 2C, the example continues with the same three networks providing data services. However, since the satellite network 210 is designated as a download only data network service at this time, the device 142 may identify that the overall download speed is sufficient in light of a download data rate threshold and the upload data rate is below the upload data rate threshold. In this case, the cellular access network 250 may be designated as an upload only data channel 208 for a period of time. The decision to switch from a bidirectional data channel to a unidirectional data channel may be based on various factors including a specific application use at a particular time, a measured aggregated download and/or upload data rate at a particular time, etc. If the aggregated upload data rate is deemed to be below a minimum upload data rate, one or more of the channels may be switched to a unidirectional direction only, such as upload only to mitigate the loss in the aggregated upload data rate.

FIG. 2D illustrates a client device managing data services from four networks where three networks are used primarily for unidirectional data services according to example embodiments. Referring to FIG. 2D, in this example, the previous three data service providers may be continuing to provide data in the manner prescribed by the example in FIG. 2B, however, an additional data service, such as satellite service 220 may begin offering data services in a similar manner to the other satellite service 210 (e.g., download only). The new data flow 210 may be combined with the previous three data flows. The current data configuration may include data being provided in the download direction by three different data sources and uploaded data is only provided by data flows 204 and 208. The decision to create such a specific data flow scenario may be automatically invoked depending on a current status or application usage of the device. In one example, the client device 142 may be streaming data from a remote server, such as a movie or television application. The amount of upload data is largely overshadowed by the amount of download data at that current time. The client device will seek to maximize download data at that time until the application use is completed or the client device is using data in a different manner, such as less downloading or more uploading over a period of time. Only one channel 204 in this example is offering bidirectional data flow.

The artificial intelligence (AI) used to optimize data connections by a VPN server may include a procedure for tracking individual applications used by a client device 142. A first application being used and requiring data communications may be denoted A1 and may have a corresponding upload data threshold target Th(u1) and a download data threshold target Th(d1). Additionally, there may be another application denoted A2 which has an upload data threshold target Th(u2) and a download data threshold target Th(d2). Those thresholds may represent values which are sought by the application to perform optimal data communications necessary for the data application to operate optimally. If a particular connection is being used by the client device 142 and one or more of the application thresholds are not achieved at any particular time, additional channels may be added and bonded with the existing channel being used to increase the upload/download data rate for the client device. Also, the channels may have a corresponding cost measurement that is identified by the client device 142, such as cost value C1 for a particular channel (satellite) and a cost value C2 for a particular channel (cellular). The cost of satellite may be higher for upload speeds and/or data rates over time. The cellular data channel may have optimal download and upload speeds, but the cost per unit data may be higher over time. An application may be evaluated for cost use over time and may have its operational parameters modified to lower costs. For example, if a client device 142 is using streaming data on a streaming application, the cost C2 may be considered too high over time so the data rate may be limited to a low quality video feed as opposed to a higher quality video feed, especially over an extended period of time. The high cost variable may cause a change in channels to invoke use of a lower cost channel to another channel to bond with the higher cost channel to reduce overall data throughput and to lower overall data use costs experienced by the single channel with a high data cost.

Certain performance metrics, such as latency could be identified by the VPN server 112 and/or a VPN client application on the client device 142 for each potential connection/channel that has become available, and that performance metric could be used as a basis for inclusion for that channel with the other channels depending on variables such as application requirements. In operation, a real time live streaming application’s data usage may require download and upload latency specifications as well as data rate considerations. The use of such a bidirectional data type of application may cause a combination of network selections to be made and setup so certain channels are operating unidirectionally while others are operating bidirectionally.

In one example, when an actively used connection fails and data compensation is needed to fulfill a target upload and/or a target download data rate, automated channel selection and combining may be performed based on what is available. Also, the upload and/or download data thresholds are dynamic and may be changed depending on various factors. The modifications may be based on the connection data that is available and the AI module portion of the VPN server 112 and/or client VPN application. In one example, an application’s use is identified and the current circumstances may have changed. As a result, the upload and download thresholds are modified dynamically based on a latency, jitter or other data metric test performed periodically and/or via known attributes of the application itself and the connections available. As the data rate and other metric value based thresholds change, certain decisions may be made to change existing channels’ directional usage, such as going from bidirectional to unidirectional or vice versa on each channel, and/or adding additional channels data flow. Also, monitoring available bandwidth, data rate, may be performed along with a determination as to how unstable or stable a connection is at a moment in time.

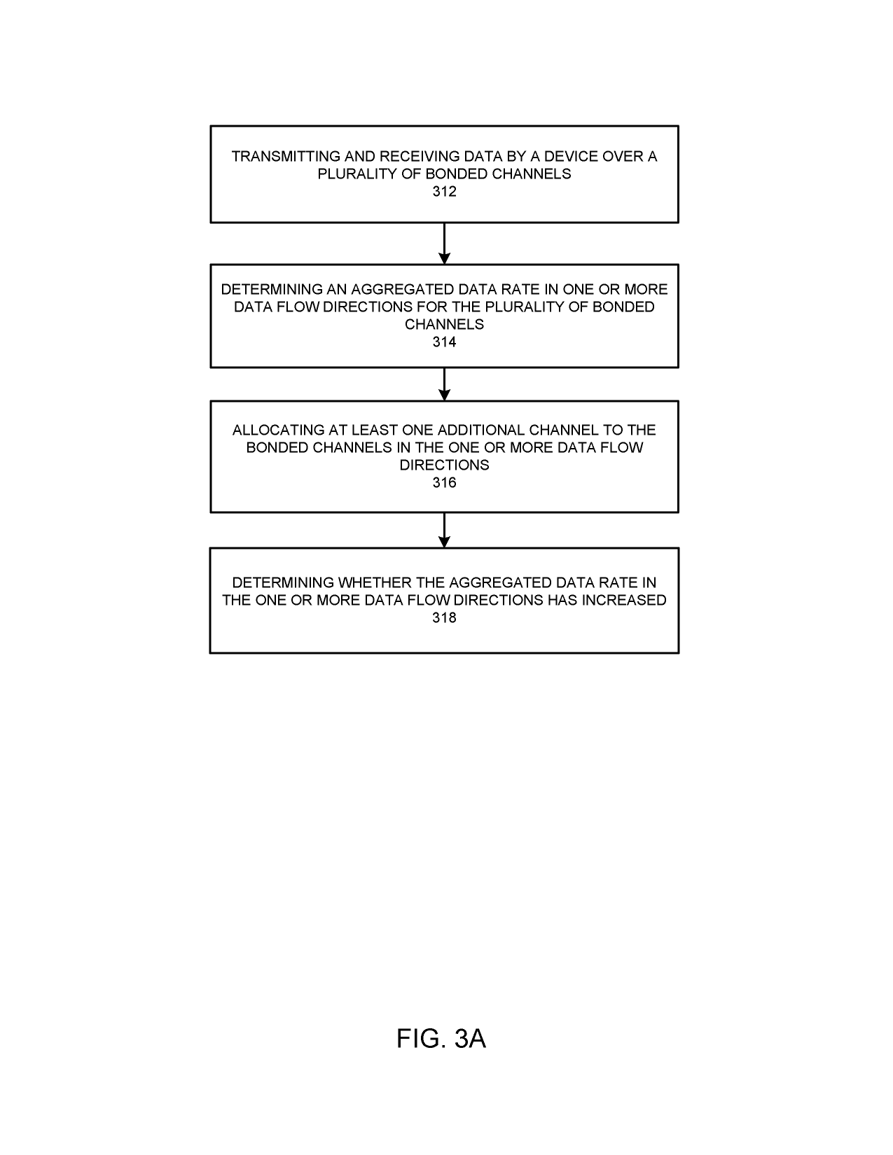

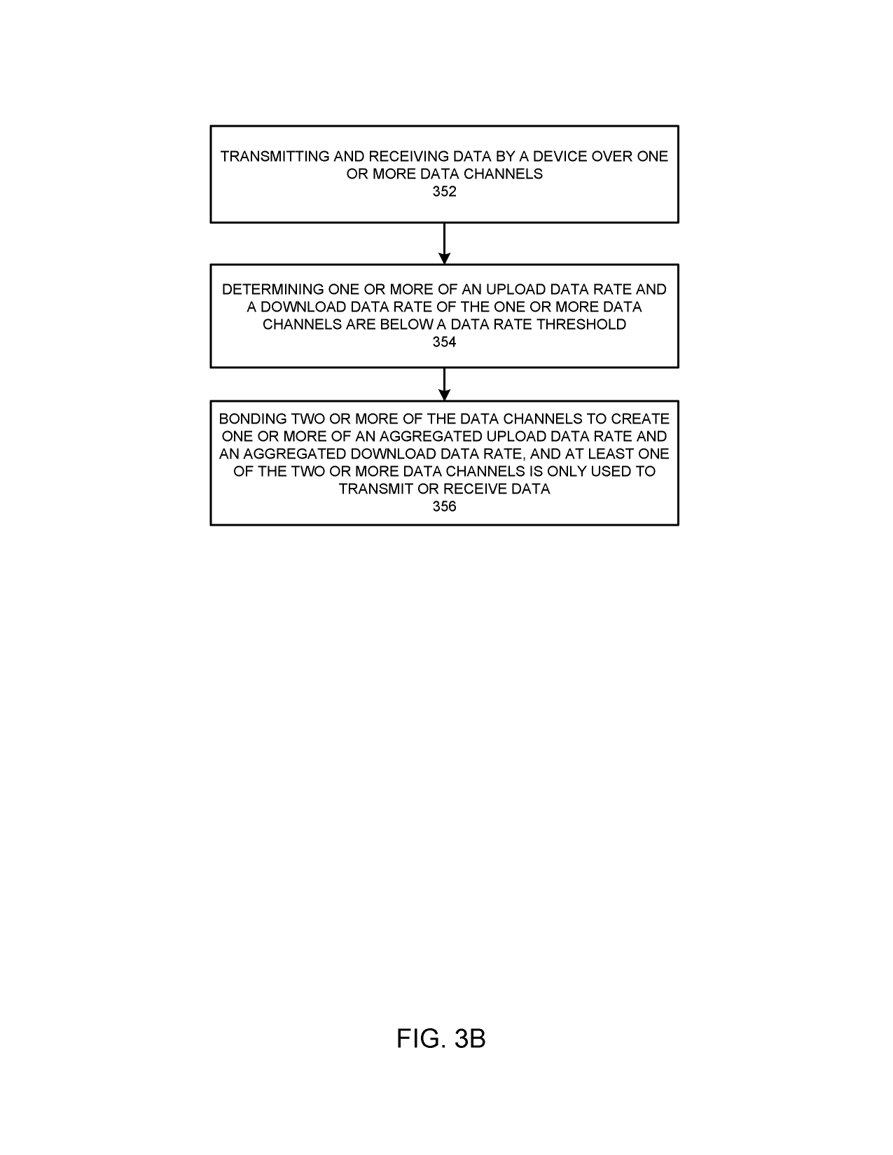

FIG. 3A illustrates an example flow diagram of an example data management process according to example embodiments. Referring to FIG. 3A, the process may include a data rate limit which could limit the data rate in one direction as low as zero bits per second and a data rate limit where certain packets such as packets required to maintain the connection or acknowledgement packets are allowed without the data rate limit being applied. In one example, the process may include transmitting and receiving data by a device over a plurality of bonded channels 312, determining an aggregated data rate in one or more data flow directions for the plurality of bonded channels 314, allocating at least one additional channel to the bonded channels in the one or more data flow directions, and determining whether the aggregated data rate in the one or more data flow directions has increased 316. The one or more data flow directions may be data flow in an upload direction. The one or more data flow directions may include data flow in a download direction.

The process may include dedicating the at least one additional channel to only one data flow direction, transmitting and receiving subsequent data over one or more of the plurality of bonded channels, and the at least one additional channel is only used for transmitting in the one data flow direction. The process may also include determining the aggregated data rate in one or more data flow directions comprises an upload data rate that is below a threshold, and determining the increased aggregated data rate is above a threshold. The process may also include determining the increased aggregated data rate is below a threshold, and adding another additional channel to the plurality of bonded channels.

FIG. 3B illustrates an example flow diagram of an example data management process according to example embodiments. Referring to FIG. 3B, the process may include transmitting and receiving data by a device over one or more data channels 352, determining one or more of an upload data rate and a download data rate of the one or more data channels are below a data rate threshold 354, bonding two or more of the data channels to create one or more of an aggregated upload data rate and an aggregated download data rate, and at least one of the two or more data channels is only used to transmit (upload) or receive (download) data 356. The example may include the client device uploading and downloading data over one, two, or more channels/connections. A data rate audit may be performed autonomously by a machine learning (ML) model to compare the active data rates of those data channels to predetermined data rates to determine whether data rates in the upload and/or download directions is below a target data rate. In this example, if one direction of data flow is operating at a data rate below a threshold data rate for that particular direction (upload/download), then the bonded channel may act as a new channel or additional channel that is dedicated to be bonded and to operate with one or more existing channels. The purpose of the bonding may be only to bond the two or more channels for uploading or downloading data but not both. In this example, a first channel may be used for uploading and downloading data, however, the second channel may be bonded solely to perform uploading or downloading with the first channel but not both uploading or downloading. Data may be transmitted simultaneously on two channels while only being received by one channel at a time. As a result of the purposed bonding decision, the channel bonding is only performed in a single direction but not used for the other direction. This may include transmitting/receiving alternating packets of a packet stream one per channel in an alternating manner where some packets of the stream are provided on a first channel and other unique packets of the stream are provided on a second channel. However, in the opposite data flow direction, the packets may be only moved along a single channel.

The process may also include determining a first channel includes an upload data rate that is below the upload data rate threshold and a download data rate that is above a download data rate threshold. The process may further include determining a data transfer failure has occurred with one or more of the data channels, and adding one or more additional channels to the bonded data channels. The process may also include determining the aggregated upload data rate is below the upload data rate threshold, and dedicating one or more of the data channels to only perform data uploading. The dedicated one or more data channels may use a satellite connection. One or more of the bonded channels may include a cellular connection or a Wi-Fi connection and another of the one or more bonded channels comprises a satellite connection. The process may also include testing a potential channel to include with the bonded channels, determining the potential channel aggregated with the bonded channels will not exceed the upload data rate threshold, and disregarding the potential channel.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

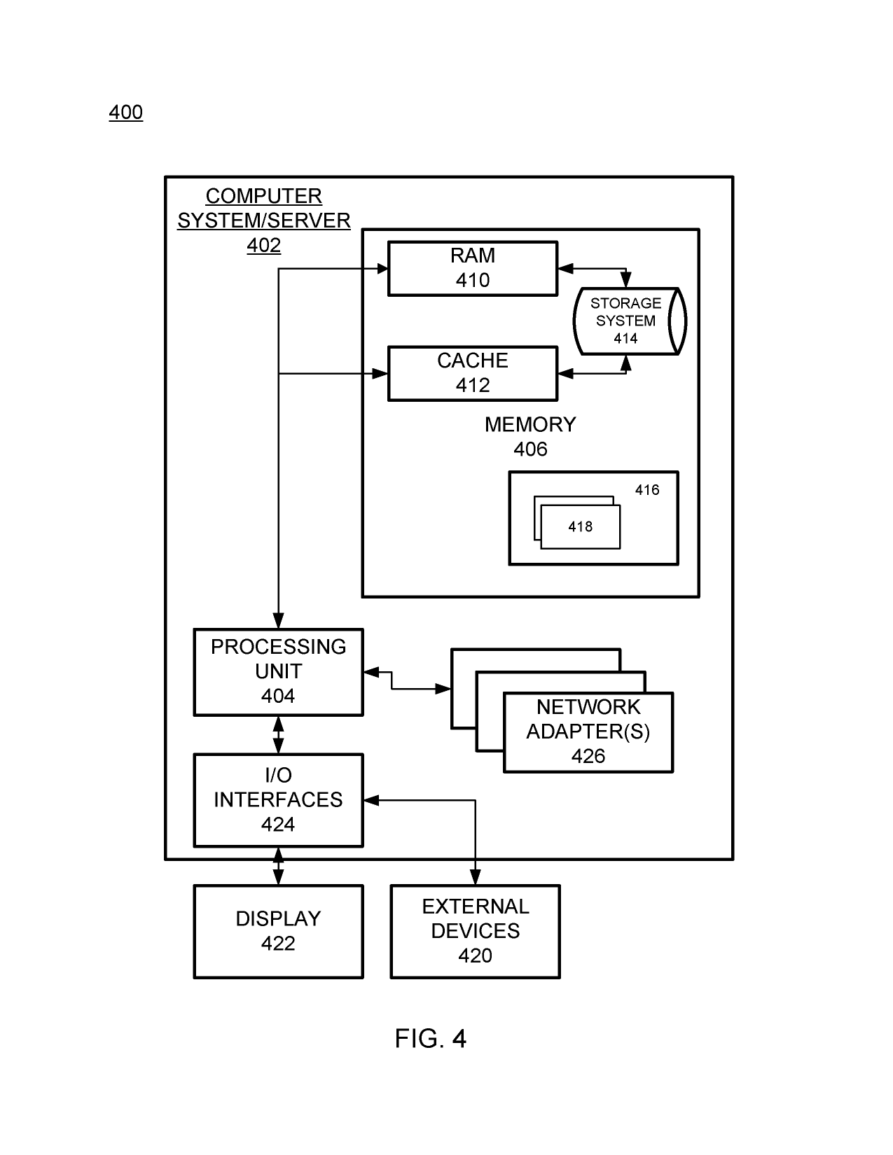

FIG. 4 illustrates an example network entity device configured to store instructions, software, and corresponding hardware for executing the same according to example embodiments. FIG. 4 is not intended to suggest any limitation as to the scope of use or functionality of embodiments of the application described herein. Regardless, the computing node 400 is capable of being implemented and/or performing any of the functionality set forth hereinabove.

In computing node 400 there is a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 402 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 4, computer system/server 402 in cloud computing node 400 is displayed in the form of a general-purpose computing device. The components of computer system/server 402 may include, but are not limited to, one or more processors or processing units 404, a system memory 406, and a bus that couples various system components including system memory 406 to processor 404.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media. System memory 406, in one embodiment, implements the flow diagrams of the other figures. The system memory 406 can include computer system readable media in the form of volatile memory, such as random-access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 406 may include at least one program product having a set (e.g., at least one) of program modules that are configured to carry out the functions of various embodiments of the application.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may include an implementation of a networking environment. Program modules 418 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 402 may also communicate with one or more external devices 420 such as a keyboard, a pointing device, a display 422, etc.; one or more devices that enable a user to interact with computer system/server 402; and/or any devices (e.g., network card, modem, etc.) that enable computer system/server 402 to communicate with one or more other computing devices. Such communication can occur via I/O interfaces 424. Still yet, computer system/server 402 can communicate with one or more networks such as a local area network (LAN), a general wide area network (WAN), and/or a public network (e.g., the Internet) via network adapter(s) 426. As depicted, network adapter(s) 426 communicates with the other components of computer system/server 402 via a bus. It should be understood that although not displayed, other hardware and/or software components could be used in conjunction with computer system/server 402. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
transmitting and receiving data by a device over one or more data channels;
determining one or more of an upload data rate and a download data rate of the one or more data channels are below a data rate threshold; and
bonding two or more of the data channels to create one or more of an aggregated upload data rate and an aggregated download data rate, wherein at least one of the two or more data channels is only used to transmit or receive data.

2. The method of claim 1, comprising
determining a first channel comprises an upload data rate that is below the upload data rate threshold and a download data rate that is above a download data rate threshold.

3. The method of claim 1, comprising
determining a data transfer failure has occurred with one or more of the data channels; and
adding one or more additional channels to the bonded data channels.

4. The method of claim 1, comprising
determining the aggregated upload data rate is below the upload data rate threshold; and
dedicating one or more of the data channels to only perform data uploading.

5. The method of claim 4, wherein the dedicated one or more data channels use a satellite connection.

6. The method of claim 1, wherein one or more of the bonded channels comprises a cellular connection or a Wi-Fi connection and another of the one or more bonded channels comprises a satellite connection.

7. The method of claim 1, comprising
testing a potential channel to include with the bonded channels;
determining the potential channel aggregated with the bonded channels will not exceed the upload data rate threshold; and
disregarding the potential channel.

8. An apparatus comprising:
a transceiver configured to transmit and receive data over one or more data channels;
a processor configured to
determine one or more of an upload data rate and a download data rate of the one or more data channels are below a data rate threshold; and
bond two or more of the data channels to create one or more of an aggregated upload data rate and an aggregated download data rate, wherein at least one of the two or more data channels is only used to transmit or receive data.

9. The apparatus of claim 8, wherein the processor is further configured to determine a first channel comprises an upload data rate that is below the upload data rate threshold and a download data rate that is above a download data rate threshold.

10. The apparatus of claim 8, wherein the processor is further configured to determine a data transfer failure has occurred with one or more of the data channels, and add one or more additional channels to the bonded data channels.

11. The apparatus of claim 8, wherein the processor is further configured to determine the aggregated upload data rate is below the upload data rate threshold, and dedicate one or more of the data channels to only perform data uploading.

12. The apparatus of claim 11, wherein the dedicated one or more data channels use a satellite connection.

13. The apparatus of claim 8, wherein one or more of the bonded channels comprises a cellular connection or a Wi-Fi connection and another of the one or more bonded channels comprises a satellite connection.

14. The apparatus of claim 8, wherein the processor is further configured to
test a potential channel to include with the bonded channels;
determine the potential channel aggregated with the bonded channels will not exceed the upload data rate threshold; and
disregard the potential channel.

15. A non-transitory computer readable storage medium configured to store instructions that when executed cause a processor to perform:
transmitting and receiving data by a device over one or more data channels;
determining one or more of an upload data rate and a download data rate of the one or more data channels are below a data rate threshold; and
bonding two or more of the data channels to create one or more of an aggregated upload data rate and an aggregated download data rate, wherein at least one of the two or more data channels is only used to transmit or receive data.

16. The non-transitory computer readable storage medium of claim 15, wherein the processor is further configured to perform:
determining a first channel comprises an upload data rate that is below the upload data rate threshold and a download data rate that is above a download data rate threshold.

17. The non-transitory computer readable storage medium of claim 15, wherein the processor is further configured to perform:
determining a data transfer failure has occurred with one or more of the data channels; and
adding one or more additional channels to the bonded data channels.

18. The non-transitory computer readable storage medium of claim 15, wherein the processor is further configured to perform:
determining the aggregated upload data rate is below the upload data rate threshold; and
dedicating one or more of the data channels to only perform data uploading.

19. The non-transitory computer readable storage medium of claim 18, wherein the dedicated one or more data channels use a satellite connection.

20. The non-transitory computer readable storage medium of claim 15, wherein the processor is further configured to perform of claim 1 , wherein one or more of the bonded channels comprises a cellular connection or a Wi-Fi connection and another of the one or more bonded channels comprises a satellite connection.
